(19) United States
(12) Patent Application Publication
(10) Pub. No.: US 2026/0297847 A1
(43) Pub. Date: Oct. 1, 2026

(54) SCREW HOUSING AND PLUG SCREW FEEDER

(71) Applicant: VALMET AB, Sundsvall (SE)

(72) Inventors: Patrik PETTERSSON, Alnö (SE); Suresh KOLAVALI, Göteborg (SE)

(73) Assignee: VALMET AB, Sundsvall (SE)

(21) Appl. No.: 19/474,889

(22) PCT Filed: Apr. 17, 2024
(86) PCT No.: PCT/SE2024/050371

§ 371 Date: Oct. 13, 2025

(30) Foreign Application Priority Data
Jun. 19, 2023 (SE) 2330287-0

(51) Int. Cl. D21C 7/06; B65G 33/14

(52) U.S. Cl. CPC D21C 7/06; B65G 33/14

(57) ABSTRACT

A material transport arrangement for transporting biomass material in a system for treatment of biomass material includes: a plug screw feeder being a force-fed plug screw feeder and including a screw housing, a plug screw and a screw pipe, wherein said plug screw includes different sections along its length direction whereof a first section is at least partly enclosed by the screw housing and a second section is at least partly enclosed by the screw pipe, and a feeding device including a force-feeding screw connected to a screw housing inlet provided in one side of the screw housing of the plug screw feeder for feeding material from one side into the screw housing, said screw housing including a substantially cylindrical inner compartment.

### TECHNICAL FIELD OF THE INVENTION

The present invention relates to a screw housing, a plug screw feeder and a material transport arrangement for transporting biomass material in a system for treatment of biomass material.

### BACKGROUND

Material transporting screws are widely used in different technical areas for transporting material inside a vessel by rotating the screw. In the pulp industry material transporting screws are used for transporting biomass material, such as lignocellulose materials, e.g. wood chips or other raw materials, such as sawdust, bagasse or straw, from one part of the pulping process to another. The material transporting screw and the vessel may be called a screw feeder or a plug screw feeder. When used in a pulping process, a plug screw feeder is typically not only used for conveying and feeding material, but is also used for dewatering of the material and to provide a pressure-tight plug to a pressurized zone, such as a digester. A material transporting screw can also be used for transporting material through a pressurized reactor vessel for pretreatment or prehydrolysis of biomass. Such a material transporting screw/plug screw typically comprises a shaft extending along the longitudinal central axis, A, throughout the whole vessel in which it is provided and a screw flight provided around the shaft in the form of a screw helix for transporting the material along the length of the vessel when the shaft is rotated. In some known plug screw feeders, anti-rotation bars are provided at an inside surface of a screw pipe which is enclosing a part of the screw. These anti-rotation bars are provided for hindering the material to only rotate inside the screw pipe but instead to be fed forward inside the screw pipe by the screw when the screw is rotated.

There are often problems related to wear in these systems. The material which is transported through the system is pressed against the inner wall of the vessel and both the plug screw and the inner wall of the vessel will be affected and eventually worn out. Hereby feeding abilities are decreased and problems may arise related to blow-back in the system, co-rotation of the material, plugging and shearing in the system.

A feeding screw may be used for feeding material into the screw feeder. A force-feeding screw may be used for example in systems where a material with comparatively low density is to be fed into a plug screw feeder. The force-feeding screw is connected to one side of a screw housing of the plug screw feeder whereby material will be fed to the plug screw feeder from only one side. Material distribution in the screw housing may not be optimal in a side fed screw feeder like this and if material is unevenly distributed around the screw there may be problems with uneven wear of the screw and the vessel, i.e. the screw and vessel will be more worn at one side compared to the other side, which will decrease working time even more.

### SUMMARY

It is an object of the invention to provide an improved screw housing and plug screw feeder in which the problems with uneven material distribution and uneven wearing of the screw feeder are decreased.

This is achieved by a screw housing for a plug screw feeder and a material transport arrangement according to the independent claims.

According to one aspect of the invention a material transport arrangement for transporting biomass material in a system for treatment of biomass material is provided. Said material transport arrangement comprises a plug screw feeder being a force-fed plug screw feeder and comprising a screw housing, a plug screw and a screw pipe, wherein said plug screw comprises different sections along its length direction whereof a first section is at least partly enclosed by the screw housing and a second section is at least partly enclosed by the screw pipe. Said material transport arrangement further comprising a feeding device comprising a force-feeding screw connected to a screw housing inlet provided in one side of the screw housing of the plug screw feeder for feeding material from one side into the screw housing, said screw housing comprising a substantially cylindrical inner compartment. The screw housing comprises at least one long anti-rotation bar provided to an inner surface of the screw housing and reaching along at least ¾ of a length, I2, of the screw housing, wherein said at least one long anti-rotation bar is provided in a lengthwise section of the inner surface, wherein said lengthwise section is provided along the whole length, I2, of the screw housing and does not comprise the screw housing inlet. The closest distance, d, along a circumference of the inner compartment between said at least one long anti-rotation bar and a center, c, of the screw housing inlet is less than ⅖ of the circumference of the inner compartment or less than ⅓ of the circumference of the inner compartment.

According to another aspect of the invention a screw housing to be used in a plug screw feeder of a material transport arrangement as defined above according to the invention is provided. Said screw housing comprises a substantially cylindrical inner compartment and being configured for at least partly enclosing the first section of the plug screw of the plug screw feeder, said screw housing comprising a screw housing inlet, whereby material is to be fed into the plug screw feeder via the screw housing inlet from the feeding device, wherein the screw housing comprises at least one long anti-rotation bar provided to an inner surface of the screw housing and reaching along at least ¾ of a length, I2, of the screw housing, wherein said at least one long anti-rotation bar is provided in a lengthwise section of the inner surface, wherein said lengthwise section is provided along the whole length, I2, of the screw housing and does not comprise the screw housing inlet, wherein the closest distance, d, along a circumference of the inner compartment between said at least one long anti-rotation bar and a center, c, of the screw housing inlet is less than ⅖ of the circumference of the inner compartment or less than ⅓ of the circumference of the inner compartment.

Thanks to the at least one long anti-rotation bar provided in the screw housing the material which is fed from one side of the screw housing by a connected feeding device will be better distributed within the screw housing. Co-rotation of the material is prevented or decreased by the long anti-rotation bar. Hereby material which is fed into the plug screw feeder will be better distributed around the plug screw and hereby there will be less problem with uneven wear of the screw and screw pipe. Hereby the screw and also the screw pipe which is enclosing a part of the screw can be used for a longer time whereby costs are saved.

In one embodiment of the invention the at least one long anti-rotation bar reaches over essentially the whole length, I2, of the screw housing.

In one embodiment of the invention the at least one long anti-rotation bar is reaching along a direction being substantially the same as a direction of a central axis, A, of the cylindrical inner compartment.

In one embodiment of the invention the at least one long anti-rotation bar has a bent form.

In one embodiment of the invention the screw housing further comprises at least one short anti-rotation bar provided to the inner surface of the screw housing and reaching along a part of the length, I2, of the screw housing being less than ¾.

In one embodiment of the invention said at least one short anti-rotation bar is positioned in line with another anti-rotation bar provided in the screw pipe to which said screw housing is to be connected.

### BRIEF DESCRIPTION OF THE DRAWINGS

FIG. 1 is a schematic, perspective view of a part of a system for treatment of biomass material.

FIG. 2 shows schematically in cross section a material transport arrangement comprising a plug screw feeder.

FIG. 3a shows an inside of a screw housing according to one embodiment of the invention.

FIG. 3b shows an inside of a screw housing according to another embodiment of the invention.

### DETAILED DESCRIPTION OF EMBODIMENTS

In the drawings, similar or corresponding elements will be denoted by the same or similar reference numbers.

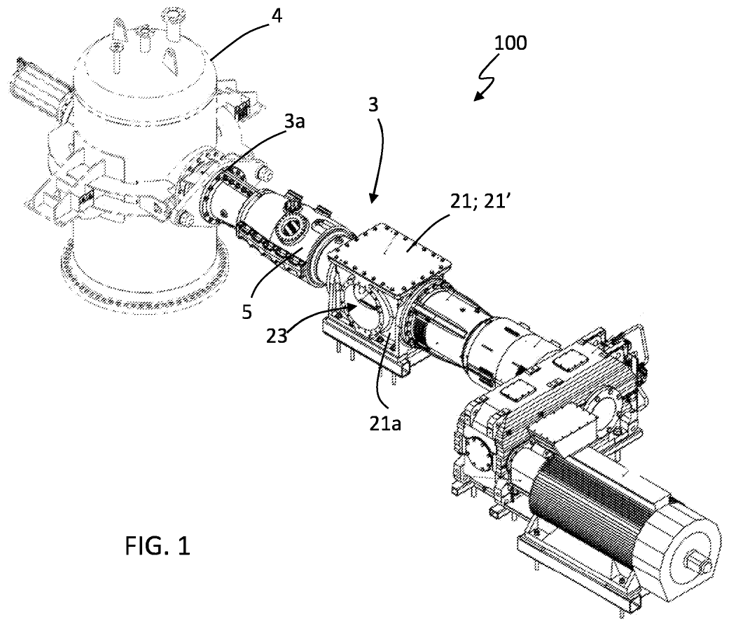

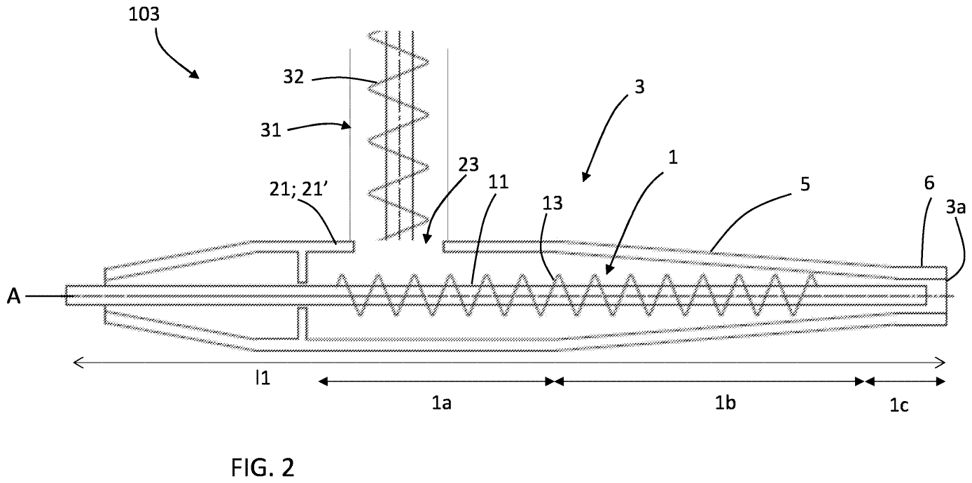

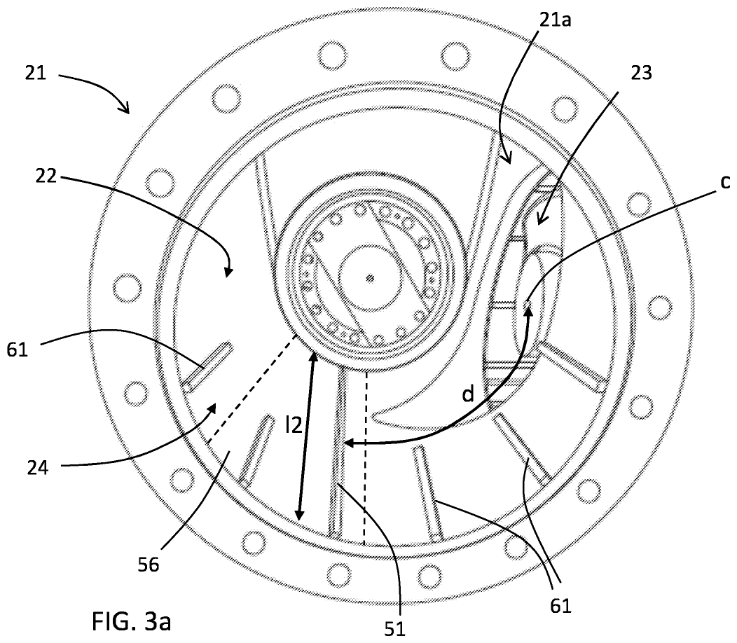

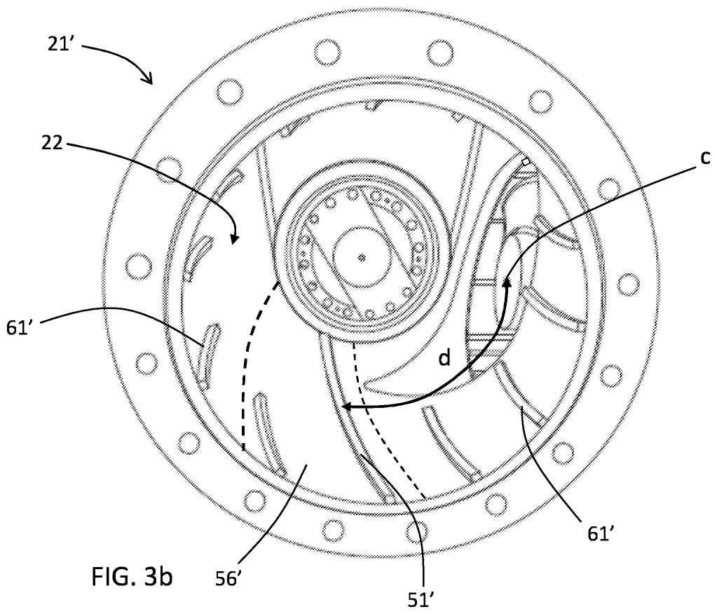

FIG. 1 is a schematic, perspective view of a part of a system 100 for treatment of biomass material. The system comprises a plug screw feeder 3 according to one embodiment of the invention. The plug screw feeder 3 according to the invention may be used in different parts of a system 100 for treatment of biomass material. The plug screw feeder 3 is used for transporting material in the system. It is also used to provide a pressure-tight plug to a pressurized zone in the system, such as a digester 4, to which an outlet 3a of the plug screw feeder 3 shown in FIG. 1 is connected. FIG. 2 shows schematically in cross section a material transport arrangement 103 comprising a plug screw feeder 3. With reference to both FIG. 1 and FIG. 2 the plug screw feeder 3 is now described in general terms. FIG. 2 shows a plug screw feeder 3 schematically, without any details which are specific for the invention. The invention specific details are instead shown in FIGS. 3a and 3b and will be discussed further below. The plug screw feeder 3 comprises a screw 1 comprising a central shaft 11 configured to extend along a length, I1, of the plug screw feeder 3 and a helical screw blade 13 provided around the central shaft 11. The screw 1 can be divided into different sections along its length, in this example: a first section 1a, a second section 1b and a third section 1c. The plug screw feeder 3 comprises furthermore a screw housing 21 which at least partly encloses the first section 1a of the screw 1 and a screw pipe 5 which at least partly encloses the second section 1b of the screw 1. In this example the plug screw feeder 3 further comprises a plug pipe 6 which at least partly encloses the third section 1c of the screw 1. The screw housing 21 of the plug screw feeder 3 comprises a screw housing inlet 23, whereby material is to be fed into the plug screw feeder 3 via the screw housing inlet 23 of the screw housing 21, from a connected feeding device 31. The connected feeding device 31 comprises a feeding screw 32, for example a force-feeding screw. Hereby material is fed into the screw housing 21 of the plug screw feeder 3 from one side. This is schematically shown in FIG. 2. In FIG. 1 no feeding device 31 is shown. However, the screw housing inlet 23 to which a feeding device 31 is to be connected can be seen in FIG. 1 and it can be seen how material will be fed from one side of the plug screw feeder 3 via the screw housing inlet 23. Such a plug screw feeder 3 which is fed from one side in contrast to a gravity fed screw feeder which is fed from above, can also be called a side fed screw feeder.

The invention will now be described with reference to FIGS. 1-2, and further with reference to FIGS. 3a and 3b. According to the invention a screw housing 21; 21′ to be used in a plug screw feeder 3 for transporting biomass material in a system 100 for treatment of biomass material is provided. According to the invention a plug screw feeder 3 and a material transport arrangement 103 are also provided. FIGS. 3a and 3b show an inside of a screw housing 21; 21′ according to two different embodiments of the invention. These are views of the screw housing 21; 21′ as a separate part. When in use the first section 1a of the screw 1 is provided within the screw housing 21; 21′ as shown schematically in FIG. 2. When in use the screw housing 21; 21′ is also connected to the screw pipe 5 as also shown schematically in FIG. 2. The screw housing 21; 21′ has an inner surface 22 which has a substantially cylindrical form. Substantially is used here to cover an opening in the inner surface 22, which opening is a screw housing inlet 23 further described below. Hereby the screw housing 21; 21′ comprises a substantially cylindrically shaped inner compartment 24 in which the first section 1a of the screw 1 is to be provided. The screw housing inlet 23 allows material to be fed into the inner compartment 24 of the screw housing 21; 21′.

The screw housing 21; 21′ is configured for at least partly enclosing said first section 1a of the plug screw 1 of the plug screw feeder 3. The screw housing 21; 21′ is also configured for connection to the screw pipe 5 of the plug screw feeder 3. The screw housing 21; 21′ comprises a screw housing inlet 23 positioned in a side wall 21a of the screw housing 21; 21′, whereby material is to be fed into the screw housing 21; 21′ and hereby into the plug screw feeder 3 via the screw housing inlet 23. The screw housing inlet 23 is configured for connection to a feeding device 31 comprising a force-feeding screw 32 as shown in FIG. 2. The side wall 21a is in use often oriented to a side, as shown in FIG. 1, such that the force-feeding screw 32 is provided along a horizontal axis. However, the force-feeding can of course be provided from any position around the circumference of the screw housing 21; 21′, also from the top.

According to the invention the screw housing 21; 21′ comprises at least one long anti-rotation bar 51; 51′ which is provided to the inner surface 22 of the screw housing 21; 21′. It is known to provide anti-rotation bars at an inner surface of the screw pipe 5 in order to achieve efficient plug screw feeding and avoid co-rotation of the material. Such anti-rotation bars generally serve to facilitate forward motion of the flow of chips/pulp in a feed direction and prevent rotation of the flow. Anti-rotation bars can be provided as elongated bars attached to the inner surface or as recesses processed in the inner surface. In this invention a position and extension of one or more anti-rotation bars in the screw housing 21; 21′ has been evaluated. It has been found that co-rotation of the material is avoided and thereby distribution of material within the screw housing 21; 21′ will be more uniform when at least one long anti-rotation bar 51; 51′ is provided which is reaching along at least ¾ of a length, I2, of the screw housing 21; 21′. The length, I2, of the screw housing is defined along the same direction as a central axis, A, of the cylindrical inner compartment 24. Furthermore said at least one long anti-rotation bar 51; 51′ is provided in a lengthwise section 56; 56′ of the inner surface 22, wherein said lengthwise section 56; 56′ is provided along the whole length, I2, of the screw housing 21; 21′ and does not comprise the screw housing inlet 23. This lengthwise section 56; 56′ is illustrated in FIGS. 3a and 3b as a section of the inner surface 22 between two dotted lines. This can be a straight lengthwise section 56 as illustrated in FIG. 3a or a curved lengthwise section 56′ as illustrated in FIG. 3b. Said at least one long anti-rotation bar 51; 51′ can be elongated bars extending from the inner surface 22 or elongated recesses in the inner surface. In some embodiments of the invention the at least one long anti-rotation bar 51; 51′ reaches over essentially the whole length I2 of the screw housing 21; 21′. In one embodiment of the invention, as shown in FIG. 3a, the at least one long anti-rotation bar 51 is reaching along a direction being substantially the same as a direction of a central axis, A, of the cylindrical inner surface 61. This central axis, A, is the same as the central axis, A, of the screw 1 as shown in FIG. 2. In another embodiment of the invention, as shown in FIG. 3b, the at least one long anti-rotation bar 51′ has a bent or spiral-like form. More than one long anti-rotation bar 51; 51′ can be provided separated around the inner circumference of the screw housing 21; 21′.

The position of the at least one long anti-rotation bar 51; 51′ according to one embodiment of the invention can be described by defining a distance, d, between the long anti-rotation bar 51; 51′ and a center, c, of the screw housing inlet 23. The closest distance along a circumference of the inner compartment 24 of the screw housing 21; 21′ between said at least one long anti-rotation bar 51; 51′ and the center, c, of the screw housing inlet 23 is in one embodiment of the invention less than ⅖ of the circumference of the inner compartment 24. In another embodiment of the invention this distance is less than ⅓ of the circumference of the inner compartment 24.

The at least one long anti-rotation bar 51; 51′ is according to one embodiment of the invention positioned such that material which is fed into the screw housing 21; 21′ via the screw housing inlet 23 and which is forced to move inside the screw housing 21; 21′ by the enclosed plug screw 1 when the plug screw is rotating, will reach the long anti-rotation bar 51; 51′ after having rotated inside the screw housing 21; 21′ around the screw 1 at least 200°or in another embodiment at least 220°.

The height or depth of the at least one long anti-rotation bar 51; 51′ can be for example between 5-40 mm. This may depend on the diameter of the screw housing 21; 21′. The heigh or depth can also be for example between 1/10 and 1/100 of a diameter of the screw housing 21; 21′. A width of the at least one long anti-rotation bar 51; 51′ can in one example be substantially the same as the depth or height. However, the width can be varied. The material of the at least one long anti-rotation bar 51; 51′ is suitably from a hardwearing and durable material. In some examples the material is the same as the material of the screw housing 21; 21′.

According to some embodiments of the invention the screw housing 21; 21′ further comprises at least one short anti-rotation bar 61; 61′ provided to the inner surface 22 of the screw housing 21; 21′ and reaching along a part of the length, I2, of the screw housing 21; 21′ being less than ¾. In FIG. 3a five short anti-rotation bars 61 are shown positioned separated over the circumference of the inner surface 22 and extending along a direction being substantially the same as the direction of the central axis, A, of the cylindrical inner surface 22. In the embodiment shown in FIG. 3b 12 short anti-rotation bars 61′ are shown positioned separated over the circumference of the inner surface 22. The number of short anti-rotation bars 61; 61′ can of course be varied. In the embodiment shown in FIG. 3b the short anti-rotation bars 61′ are bent or spiral-shaped.

In one embodiment of the invention said one or more short anti-rotation bars 61; 61′ are positioned in line with other anti-rotation bars provided in the screw pipe 5 to which said screw housing 21; 21′ is to be connected. A height or depth, a width and a material of the at least one short anti-rotation bar 61; 61′ can for example be the same as for the at least one long anti-rotation bar 51; 51′ as described above.

Both the long and short anti-rotation bars 51, 61; 51′, 61′ are provided to facilitate forward motion of the flow of chips/pulp in a feed direction and prevent co-rotation of the material and to provide a uniform material distribution inside the screw housing 21; 21′.

A plug screw feeder 3 for transporting biomass material in a system 100 for treatment of biomass material is also provided according to the invention. Said plug screw feeder 3 is a force-fed plug screw feeder and comprises a screw housing 21; 21′ according to the invention as described above. The plug screw feeder 3 comprises furthermore a plug screw 1 and a screw pipe 5, wherein said plug screw 1 comprises different sections along its length direction whereof a first section 1a is at least partly enclosed by the screw housing 21; 21′ and a second section 1b is at least partly enclosed by the screw pipe 5.

A material transport arrangement 103 for transporting biomass material in a system 100 for treatment of biomass material is also provided according to the invention. Said material transport arrangement 103 comprises a plug screw feeder 3 according to the invention as described above and a feeding device 31 comprising a force feeding screw 32 connected to the screw housing inlet 23 in one side of the screw housing 21; 21′ of the plug screw feeder 3 for feeding material from one side into the screw housing 21. The plug screw 1 of the plug screw feeder 3 and the force-feeding screw 32 of the feeding device 31 are arranged to have their respective rotational axes perpendicular to each other.

1-9. (canceled)

10. A material transport arrangement for transporting biomass material in a system for treatment of biomass material, said material transport arrangement comprising:
a plug screw feeder being a force-fed plug screw feeder and comprising a screw housing, a plug screw and a screw pipe, wherein said plug screw comprises different sections along its length direction whereof a first section is at least partly enclosed by the screw housing and a second section is at least partly enclosed by the screw pipe, and
a feeding device comprising a force-feeding screw connected to a screw housing inlet provided in one side of the screw housing of the plug screw feeder for feeding material from one side into the screw housing, said screw housing comprising a substantially cylindrical inner compartment,
wherein the screw housing comprises at least one long anti-rotation bar provided to an inner surface of the screw housing and reaching along at least ¾ of a length of the screw housing, wherein said at least one long anti-rotation bar is provided in a lengthwise section of the inner surface, wherein said lengthwise section is provided along the whole length of the screw housing and does not comprise the screw housing inlet, and
wherein a closest distance along a circumference of the inner compartment between said at least one long anti-rotation bar and a center of the screw housing inlet is less than ⅖ of the circumference of the inner compartment.

11. Material transport arrangement according to claim 10, wherein the at least one long anti-rotation bar reaches over essentially the whole length of the screw housing.

12. Material transport arrangement according to claim 10, wherein the at least one long anti-rotation bar is reaching along a direction being substantially the same as a direction of a central axis of the cylindrical inner compartment.

13. Material transport arrangement according to claim 10, wherein the at least one long anti-rotation bar has a bent form.

14. Material transport arrangement according to claim 10, wherein the screw housing further comprises at least one short anti-rotation bar provided to the inner surface of the screw housing and reaching along a part of the length of the screw housing being less than ¾.

15. Material transport arrangement according to claim 14, wherein said at least one short anti-rotation bar is positioned in line with another anti-rotation bar provided in the screw pipe to which said screw housing is to be connected.

16. Material transport arrangement according to claim 10, wherein the plug screw of the plug screw feeder and the force-feeding screw of the feeding device are arranged to have their respective rotational axes perpendicular to each other.

17. Material transport arrangement according to claim 10, wherein the at least one long anti-rotation bar is positioned such that material which is fed into the screw housing via the screw housing inlet and which is forced to move inside the screw housing by the enclosed plug screw when the plug screw is rotating, will reach the at least one long anti-rotation bar after having rotated inside the screw housing around the plug screw at least 200°or at least 220°.

18. A screw housing to be used in a plug screw feeder of a material transport arrangement according to claim 10, said screw housing comprising:
a substantially cylindrical inner compartment and being configured for at least partly enclosing the first section of the plug screw of the plug screw feeder, said screw housing comprising a screw housing inlet, whereby material is to be fed into the plug screw feeder via the screw housing inlet from the feeding device, wherein the screw housing comprises at least one long anti-rotation bar provided to an inner surface of the screw housing and reaching along at least ¾ of a length of the screw housing, wherein said at least one long anti-rotation bar is provided in a lengthwise section of the inner surface, wherein said lengthwise section is provided along the whole length of the screw housing and does not comprise the screw housing inlet,
wherein a closest distance along a circumference of the inner compartment between said at least one long anti-rotation bar and a center of the screw housing inlet is less than ⅖ of the circumference of the inner compartment.
